(19) United States
(12) Patent Application Publication
(10) Pub. No.: US 2024/0234677 A1
(43) Pub. Date: Jul. 11, 2024

(54) METHOD OF MANUFACTURING ELECTRODE FOR SECONDARY BATTERY

(71) Applicant: TOYOTA JIDOSHA KABUSHIKI KAISHA, Toyota-shi (JP)

(72) Inventor: Toru KOMATSUZAKI, Toyota-shi (JP)

(73) Assignee: TOYOTA JIDOSHA KABUSHIKI KAISHA, Toyota-shi (JP)

(21) Appl. No.: 18/545,266

(22) Filed: Dec. 19, 2023

(30) Foreign Application Priority Data
Jan. 10, 2023 (JP) 2023-001672

(51) Int. Cl. H01M 4/04

(52) U.S. Cl. CPC H01M 4/0435

(57) ABSTRACT

A method of manufacturing an electrode for a secondary battery includes: preparing an electrode sheet including a plurality of strip electrode layers provided on a first surface of a substrate and arranged at intervals in a first direction, and a sheet electrode layer provided on a second surface of the substrate opposite to the first surface and continuous in the first direction; and pressing the electrode sheet transported in a transport direction crossing the first direction, using a plurality of pairs of rollers displaced from each other in the first direction. In the pressing, the strip electrode layers and the sheet electrode layer are held between rollers of the plurality of pairs of rollers, in a state where opposite ends, in the first direction, of each roller are located at respective positions that do not overlap the strip electrode layers, as seen in a normal direction to the first surface.

### CROSS REFERENCE TO RELATED APPLICATIONS

This nonprovisional application is based on Japanese Patent Application No. 2023-001672 filed on Jan. 10, 2023 with the Japan Patent Office, the entire contents of which are hereby incorporated by reference.

### BACKGROUND

### Field

The present disclosure relates to a method of manufacturing an electrode for a secondary battery.

### Description of the Background Art

As a conventional method of manufacturing a negative electrode used in an electrode for a secondary battery, Japanese Patent Laying-Open No. 2015-138619 discloses a technique of providing a step of forming a negative electrode active material layer by applying a negative electrode active material paste containing negative electrode active material particles onto a negative electrode current collector and drying the negative electrode active material paste, and a step of providing a solvent to the negative electrode active material layer and pressing a mold having a concave-convex pattern to transfer the concave-convex pattern to the negative electrode active material layer.

In Japanese Patent Laying-Open No. 2015-138619, a wound electrode is manufactured by winding a negative electrode sheet having a negative electrode active material layer with a concave-convex pattern and a positive electrode sheet having a positive electrode active material layer formed thereon with a separator interposed therebetween.

### SUMMARY

As a method of manufacturing an electrode for a secondary battery, there is known a method in which an electrode sheet in which a positive electrode active material layer is formed on one surface of a current collector and a negative electrode active material layer is formed on the other surface of the current collector is pressed by a pair of rollers. A multilayer electrode is produced by stacking a plurality of pressed electrode sheets with a separator interposed therebetween.

In recent years, with an increase in capacity of a secondary battery, it has been studied to use a current collector having a high area with a width of 1 m or more as a current collector.

In the multilayer electrode, 100 or more pressed electrode sheets (electrodes for a secondary battery) may be stacked. In order to suppress variation in height in the stacking direction, it is desirable to uniformly press the electrode sheets so as to suppress variation in thickness in the plane of the electrode sheet.

When an electrode sheet having a press width exceeding 1 m is pressed by a pair of rollers, it is required to press the electrode sheet or to secure a desired press pressure in consideration of bending of the roller or the like. In such a case, it is required to design a roller having a convex central portion in the axial direction and a press facility having high rigidity while increasing the size, and the design of the facility becomes advanced and complicated.

Further, when the active material layer is formed over a wide range without division, penetration of the electrolyte solution is suppressed. In order to increase the permeability of the electrolyte solution, one of the positive electrode active material layer and the negative electrode active material layer may be divided. When the electrode sheet provided with the divided active material layer and the undivided active material layer is pressed together by a pair of rollers, a gap is formed between the active material layers that are divided and adjacent to each other, whereby the design of the pair of rollers and the control thereof are further complicated. This may cause variations in thicknesses and densities of the positive electrode active material layer and the negative electrode active material layer.

It is an object of the present disclosure to provide a method of manufacturing an electrode for a secondary battery that enables suppression of variation in density and thickness of the electrode layer.

According to the present disclosure, a method of manufacturing an electrode for a secondary battery includes: preparing an electrode sheet including a plurality of strip electrode layers provided on a first surface of a substrate, the strip electrode layers being arranged at intervals in a first direction, and a sheet electrode layer provided on a second surface of the substrate opposite to the first surface, the sheet electrode layer being continuous in the first direction; and pressing the electrode sheet transported in a transport direction crossing the first direction, using a plurality of pairs of rollers arranged to be displaced from each other in the first direction. In the pressing, the plurality of strip electrode layers and the sheet electrode layer are held between rollers of the plurality of pairs of rollers, in a state where opposite ends, in the first direction, of each of the rollers are located at respective positions that do not overlap the plurality of strip electrode layers, as seen in a normal direction to the first surface.

According to the above configuration, a plurality of strip electrode layers are arranged at intervals in the first direction, and therefore, the permeability of an electrolyte solution can be improved by means of a gap between the strip electrode layers adjacent to each other.

Further, respective predetermined regions of the electrode sheet that are arranged in the first direction can be pressed by means of the pairs of rollers, and therefore, variations in press pressure for each of the predetermined regions can be suppressed. Moreover, the predetermined regions are pressed in a state where the ends of each of the rollers in the first direction are located at respective positions that do not overlap the strip electrode layers, and therefore, the sheet electrode layer of the portion located for a respective strip electrode layer as well as the strip electrode layers can be pressed reliably with a predetermined pressure for each of the predetermined regions. Accordingly, it is possible to suppress variations in density and thickness of the sheet electrode layer and the plurality of strip electrode layers.

In the method of manufacturing an electrode for a secondary battery according to the present disclosure, as a roller of the pair of rollers that is located on the first surface, a roller is used that has a protruding portion to enter a gap between the strip electrode layers adjacent to each other in the first direction as seen in the normal direction to the first surface, the protruding portion being provided at an end of the roller, the end being located between the strip electrode layers adjacent to each other in the first direction.

According to the above configuration, it is possible to press the sheet electrode layer of the portion located at the gap, by means of the protruding portion provided on the roller disposed on the first surface and the roller disposed on the second surface. Accordingly, the sheet electrode layer and the plurality of strip electrode layers can be pressed more uniformly, to further suppress variations in density and thickness of the sheet electrode layer and the plurality of strip electrode layers.

In the method of manufacturing an electrode for a secondary battery according to the present disclosure, in the pressing, in a region corresponding to the gap, the substrate and the sheet electrode layer may be held between a roller of the pair of rollers that is located on the second surface and the protruding portion.

According to the above configuration, the protruding portion and the roller disposed on the second surface can be used to press the sheet electrode layer, even at the position corresponding to the gap. Accordingly, the sheet electrode layer and the plurality of strip electrode layers can be pressed more uniformly, which makes it possible to further suppress variations in density and thickness of the sheet electrode layer and the plurality of strip electrode layers.

In the method of manufacturing an electrode for a secondary battery according to the present disclosure, the method may include: measuring, at a site downstream of each of the plurality of pairs of rollers in the transport direction, a thickness of the strip electrode layers pressed by the plurality of pairs of rollers; and feeding back, to the pressing, information about the measured thickness. In this case, in the pressing, a press pressure for each of the plurality of pairs of rollers may be adjusted based on the fed back information.

According to the above configuration, the information about the thickness of the strip electrode layers pressed by the plurality of pairs of rollers can be fed back to adjust the press pressure of a pair of rollers, and therefore, variations in density and thickness of the sheet electrode layer and the plurality of strip electrode layers can further be suppressed.

According to the method of manufacturing an electrode for a secondary battery based on the present disclosure, at least one pair of rollers among the plurality of pairs of rollers differs from another pair of rollers, in a width in the first direction.

According to the above configuration, the width of the pairs of rollers can be adjusted to press a predetermined region of the electrode sheets arranged in the one direction, depending on the width of the electrode sheets in the first direction.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing a manufacturing apparatus for manufacturing an electrode for a secondary battery according to a first embodiment.

FIG. 2 is a top view of the manufacturing apparatus according to the first embodiment.

FIG. 3 is a front view of the manufacturing apparatus according to the first embodiment.

FIG. 4 is a flowchart showing a manufacturing flow of an electrode for a secondary battery according to the first embodiment.

FIG. 5 is a top view of a manufacturing apparatus according to a second embodiment.

FIG. 6 is a front view of a manufacturing apparatus according to a second embodiment.

### DESCRIPTION OF THE PREFERRED EMBODIMENTS

Hereinafter, embodiments of the present disclosure will be described in detail with reference to the drawings. In the following embodiments, the same or common portions are denoted by the same reference numerals, and description thereof will not be repeated.

### Embodiment 1

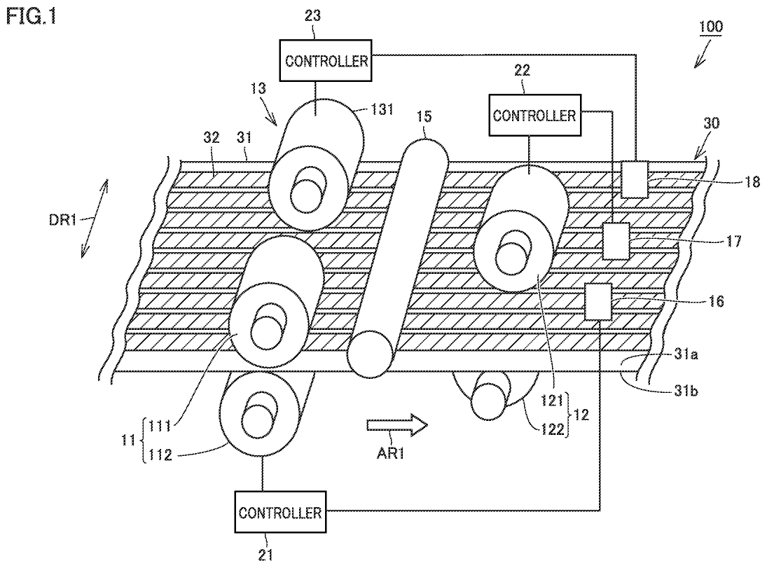

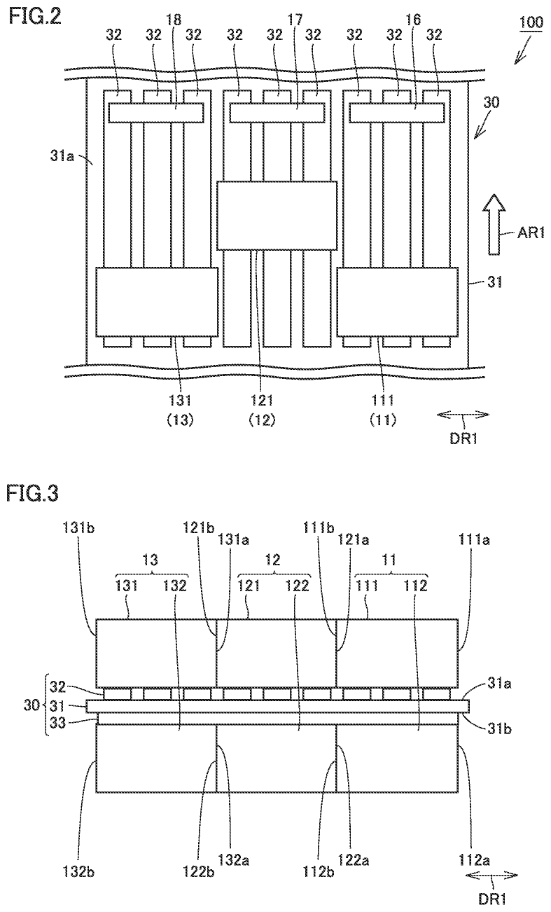

FIG. 1 is a schematic view showing a manufacturing apparatus for manufacturing an electrode for a secondary battery according to a first embodiment. FIG. 2 is a top view of the manufacturing apparatus according to the first embodiment. FIG. 3 is a front view of the manufacturing apparatus according to the first embodiment. With reference to FIGS. 1 to 3, a manufacturing apparatus 100 for an electrode for a secondary battery according to a first embodiment will be described.

As shown in FIGS. 1 to 3, the manufacturing apparatus 100 according to the first embodiment includes a plurality of rollers 11, 12, and 13, a guide roller 15, thickness meters 16, 17, and 18, and controllers 21, 22, and 23.

In the manufacturing apparatus 100, an electrode for a secondary battery is manufactured by pressing the electrode sheet 30 wound and conveyed from the winding side by a pair of rollers 11, 12, and 13. The electrode for a secondary battery is, for example, a bipolar electrode. By laminating a plurality of electrodes for a secondary battery with a separator interposed therebetween, a battery element used for a secondary battery can be formed. A plurality of secondary batteries are arranged and mounted on a vehicle such as a hybrid electric vehicle or a battery electric vehicle as a battery pack.

The electrode sheet 30 includes a substrate 31, a plurality of strip electrode layers 32, and a sheet electrode layer 33. The substrate 31 is formed in a plate shape, and has a first surface 31a and a second surface 31b opposed to each other in the thickness direction. The substrate 31 is made of, for example, a metal foil. The substrate 31 may include at least one selected from the group consisting of aluminum (Al), stainless steel, nickel (Ni), chromium (Cr), platinum (Pt), niobium (Nb), iron (Fe), titanium (Ti), and zinc (Zn). Further, the substrate 31 may be formed by subjecting the surface of the metal foil to plating.

The plurality of strip electrode layers 32 are provided on the first surface 31a of the substrate 31 so as to be arranged at intervals in the first direction (DR1 direction). The first direction is a direction orthogonal to the transport direction (AR1 direction) of the electrode sheet 30, and is parallel to the width direction of the electrode sheet 30. The width of the electrode sheet 30 is, for example, 1 m or more.

When the plurality of strip electrode layers 32 are provided at intervals in the first direction as described above, the permeability of the electrolyte solution can be improved by using the gap between the strip electrode layers 32 adjacent to each other.

Each of the plurality of strip electrode layers 32 is, for example, a positive electrode layer. The plurality of strip electrode layers 32 are formed by coating a positive electrode active material on the first surface 31a. The positive electrode active material may be applied to a region where the strip electrode layer 32 is formed. A plurality of strip electrode layers 32 may be formed by removing a part of the positive electrode active material layer coated over a wide range by a laser or the like.

The positive electrode active material layer contains a positive electrode active substance and a binder resin. The positive electrode active material is typically a lithium (Li)-containing metal oxide. The binder may be, for example, carboxymethyl cellulose (CMC), styrene-butadiene rubber (SBR), polyacrylic acid (PAA), or the like.

The sheet electrode layer 33 has a polarity opposite to that of the strip electrode layer 32. The sheet electrode layer 33 is, for example, a negative electrode layer. The sheet electrode layer 33 is formed by coating a negative electrode active material on the second surface 31b. The anode active material layer contains an anode active material and a binder resin. As the negative electrode active material, lithium, carbon, a metal compound, an element capable of alloying with lithium, a compound thereof, or the like can be used. As the binder, the same binder as described above can be adopted.

The sheet electrode layer 33 is provided on the second surface 31b of the substrate 31 so as to be continuous in the first direction. The opposite ends of the sheet electrode layer 33 in the first direction are positioned outside the plurality of strip electrode layers 32 in the first direction.

Specifically, the end of the electrode layer 33 positioned on one side in the first direction is positioned closer to the one side in the first direction than the end of the strip electrode layer 32 positioned on the one side in the first direction. The end of the electrode layer 33 positioned on the other side in the first direction is positioned closer to the other side in the first direction than the end of the strip electrode layer 32 on the other side in the first direction.

By forming the sheet electrode layer 33 in a wider region than the region where the plurality of strip electrode layers 32 are formed, it is possible to prevent a portion of the electrode layer 33 which does not face the strip electrode layer 32 from being formed. Thereby, the positive ions released from the respective strip electrode layers 32 can be reliably occluded by the sheet electrode layers 33.

The pair of rollers 11, 12, 13 is supported by a rotary shaft. The pair of rollers 11, 12, and 13 are arranged such that their center positions are displaced in the first direction. Specifically, the pair of rollers 11 is disposed on one side in the first direction. The pair of rollers 12 is disposed at the center in the first direction. The pair of rollers 13 is disposed on the other side in the first direction.

More specifically, the pair of rollers 11, 12, and 13 are arranged in a zigzag pattern. The pair of rollers 11 and the pair of rollers 13 are arranged side by side at intervals in the first direction. The pair of rollers 12 is disposed downstream of the pair of rollers 11 and 13 in the transport direction. The pair of rollers 12 is disposed such that opposite ends in the first direction overlap the pair of rollers 11 and 13 when viewed from the upstream side in the transport direction.

The pair of rollers 11, 12, 13 may have the same width in the first direction or different widths from each other. Further, the width of only one of the pair of rollers 11, 12, and 13 may be different from that of the other pair of rollers.

By adjusting the width of the pair of rollers in the first direction in this manner, a predetermined region of the electrode sheet arranged in the first direction can be pressed corresponding to the width of the electrode sheet 30 in the first direction.

The pair of rollers 11 includes a roller 111 and a roller 112. The roller 111 and the roller 112 face each other in an opposing direction orthogonal to the first direction and the transport direction. The roller 111 is disposed on the first surface 31a side. The roller 112 is disposed on the second surface 31b side.

The roller 111 and the roller 112 have substantially the same width in the first direction. The roller 111 has ends 111a and 111b on both sides in the first direction. The roller 112 has ends 112a and 112b on both sides in the first direction. The ends 111a and 112a are positioned on one side in the first direction, and the ends 111b and 112b are positioned on the other side in the first direction.

The pair of rollers 12 includes a roller 121 and a roller 122. The roller 121 and the roller 122 face each other in the opposing direction. The roller 121 is disposed on the first surface 31a side. The roller 122 is disposed on the second surface 31b side.

The roller 121 and the roller 122 have substantially the same width in the first direction. The roller 121 has ends 121a and 121b on both sides in the first direction. The roller 122 has ends 122a and 122b on both sides in the first direction. The ends 121a and 122a are positioned on one side in the first direction, and the ends 121b and 122b are positioned on the other side in the first direction.

The pair of rollers 13 includes a roller 131 and a roller 132. The roller 131 and the roller 132 face each other in the opposing direction. The roller 131 is disposed on the first surface 31a side. The roller 132 is disposed on the second surface 31b side.

The roller 131 and the roller 132 have substantially the same width in the first direction. The roller 131 has ends 131a and 131b on both sides in the first direction. The roller 132 has ends 132a and 132b on both sides in the first direction. The ends 131a and 132a are positioned on one side in the first direction, and the ends 131b and 132b are positioned on the other side in the first direction.

The pair of rollers 11, 12, and 13 is disposed such that opposite ends of each roller 111, 112, 121, 122, 131, 132 in the first direction are positioned at positions not overlapping the plurality of strip electrode layers 32 when viewed from the normal direction of the first surface 31a.

Specifically, when viewed from the normal direction, an end (specifically, the ends 111a and 112a) of the pair of rollers 11 on one side in the first direction is positioned outside an end of the strip electrode layer 32 on one side in the first direction, which is positioned on the closest side in the first direction. The one end (specifically, the ends 111a and 112a) is positioned outside the end of the electrode layer 33 positioned on the one side in the first direction.

When viewed from the normal direction, an end (specifically, the ends 111b and 112b) of the pair of rollers 11 on the other side in the first direction is disposed so as to overlap with a gap between the strip electrode layers 32 adjacent to each other.

When viewed from the normal direction, one end (specifically, the ends 121a and 122a) of the pair of rollers 12 in the first direction is disposed so as to overlap with a gap between the adjacent strip electrode layers 32. Further, the ends 121a and 122a are arranged so as to overlap the ends 111b and 112b when viewed from the upstream side in the transport direction.

When viewed from the normal direction, an end (specifically, the ends 121b and 122b) of the pair of rollers 12 on the other side in the first direction is disposed so as to overlap with a gap between the strip electrode layers 32 adjacent to each other.

When viewed from the normal direction, one end (specifically, the ends 131a and 132a) of the pair of rollers 13 in the first direction is disposed so as to overlap with a gap between the adjacent strip electrode layers 32. Further, the ends 131a and 132a are disposed so as to overlap the ends 121b and 122b when viewed from the upstream side in the transport direction. When viewed from the normal direction, an end (specifically, the ends 131b and 132b) of the pair of rollers 13 on the other side in the first direction is positioned outside an end of the strip electrode layer 32 on the other side in the first direction which is positioned closest to the other side in the first direction. The other end (specifically, the ends 131b and 132b) is positioned outside the end of the electrode layer 33 positioned on the other side in the first direction.

The guide roller 15 is disposed downstream of the pair of rollers 11, 12, 13. The guide roller 15 guides the movement of the electrode sheet 30 pressed by the pair of rollers 11, 12, and 13. The guide roller 15 suppresses vibration of the electrode sheet 30.

The thickness meters 16, 17, and 18 are positioned downstream of the guide roller 15. The thickness meters 16, 17, and 18 are, for example, laser displacement meters including a laser light source. The thickness meter 16 is disposed downstream of the pair of rollers 11, and measures the thickness of the strip electrode layer 32 pressed by the pair of rollers 11. The thickness meter 17 is disposed downstream of the pair of rollers 12, and measures the thickness of the strip electrode layer 32 pressed by the pair of rollers 12. The thickness meter 18 is disposed downstream of the pair of rollers 13 and measures the thickness of the strip electrode layer 32 pressed by the pair of rollers 13.

The measurement results (information on the thicknesses) measured by the thickness meters 16, 17, and 18 are input to the controllers 21, 22, and 23, respectively. The controllers 21, 22, and 23 adjust the press pressures of the pair of rollers 11, 12, and 13 based on the measurement results.

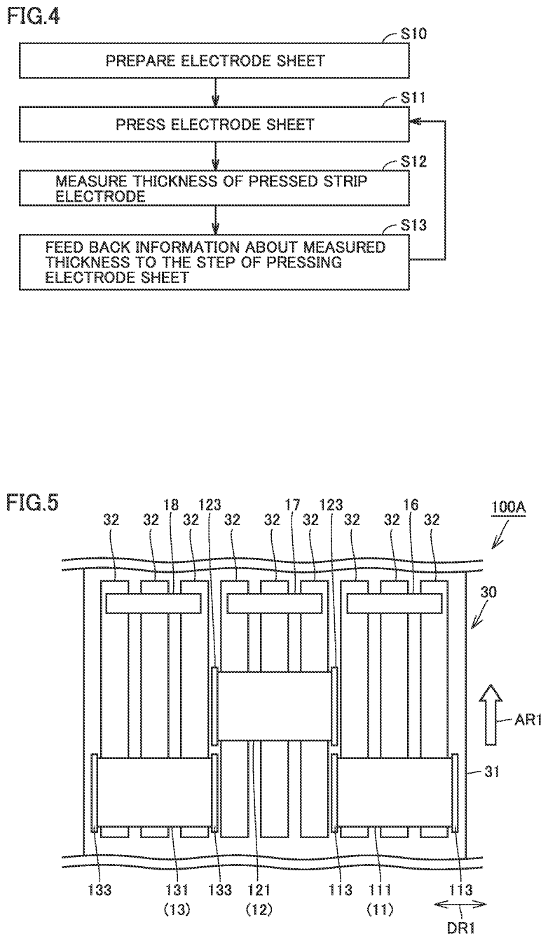

FIG. 4 is a flowchart showing a manufacturing flow of an electrode for a secondary battery according to the first embodiment. Referring to FIG. 4, a manufacturing flow of the electrode for a secondary battery according to the first embodiment will be described.

As shown in FIG. 4, when manufacturing an electrode for a secondary battery, first, in step S10, an electrode sheet 30 is prepared. Specifically, as described above, the electrode sheet 30 is prepared in which the plurality of strip electrode layers 32 are provided on the first surface 31a of the substrate 31 so as to be arranged at intervals in the first direction, and the sheet electrode layer 33 continuous in the first direction is provided on the second surface 31b of the substrate 31.

Subsequently, in step S11, the electrode sheet 30 is pressed. Specifically, in step S11, as shown in FIG. 2 and FIG. 3, the electrode sheet 30 transported in the transport direction intersecting the first direction is pressed by using a plurality of rollers 11, 12, and 13 arranged in the first direction.

At this time, when viewed from the normal direction of the first surface 31a, the pair of rollers 11, 12, and 13 sandwich the plurality of strip electrode layers 32 and the sheet electrode layers 33 in a state where opposite ends (specifically, end 111a, 111b, 112a, 112b, 121a, 121b, 122a, 122b, 131a, 131b, 132a and 132b) of each roller in the first direction are positioned at positions not overlapping the plurality of strip electrode layers 32. Thus, the plurality of strip electrode layers 32 and the sheet electrode layer 33 are adjusted to a desired density and a desired thickness, and the secondary electrode is manufactured.

The pair of rollers 11, 12, and 13 arranged in the first direction can press each of a plurality of predetermined regions arranged in the first direction in the electrode sheet 30. Therefore, it is possible to suppress variation in press pressure for each predetermined region.

Further, since the predetermined region is pressed in a state in which the ends of the pair of rollers 11, 12, and 13 in the first direction are positioned at positions not overlapping the plurality of strip electrode layers 32, the sheet electrode layer 33 and the strip electrode layer 32 at portions corresponding to the strip electrode layers 32 can be reliably pressed at a predetermined pressure for each predetermined region. Thus, variation in density and thickness between the sheet electrode layer 33 and the plurality of strip electrode layers 32 can be suppressed.

Subsequently, in step S12, the thickness of the pressed strip electrode layer is measured. More specifically, the thickness meters 16, 17, and 18 disposed on the downstream side of the pair of rollers 11, 12, and 13 are used to measure the thickness of the strip electrode layer 32 pressed by the pair of rollers 11, 12, and 13. The measurement results are input to the controllers 21, 22, and 23.

Although the case of measuring the thickness of the strip electrode layer 32 is exemplified in the above description, the thickness meters 16, 17, and 18 may be disposed on the second surface 31b side, and the thickness of the sheet electrode layer 33 may be measured by the thickness meters 16, 17, and 18.

Subsequently, in step S13, information on the measured thickness is fed back to step S11 of pressing the electrode sheet 30.

Subsequently, in step S11, the controllers 21, 22, and 23 adjust the pressures of the pair of rollers 11, 12, and 13 based on the feedback information on the thickness. Specifically, the pressure of the pair of rollers 11, 12, 13 is adjusted so that the thickness of the strip electrode layer 32 falls within a predetermined range.

By adjusting the press pressure of the pair of rollers 11, 12, 13 based on the information on the thickness fed back in this manner, it is possible to further suppress variations in density and thickness of the plurality of strip electrode layers 32, and consequently, variations in density and thickness of the sheet electrode layer 33. Steps S12 and S13 may be omitted.

### Embodiment 2

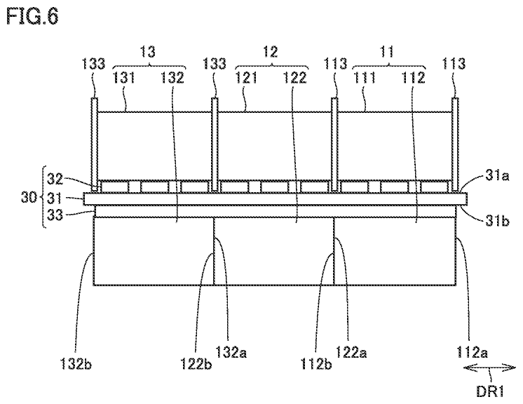

FIG. 5 is a top view of a manufacturing apparatus according to a second embodiment. FIG. 6 is a front view of a manufacturing apparatus according to a second embodiment. A manufacturing apparatus according to a second embodiment will be described with reference to FIGS. 5 and 6.

As shown in FIGS. 5 and 6, the manufacturing apparatus 100A according to the second embodiment differs from the manufacturing apparatus 100 according to the first embodiment in the configuration of a pair of rollers 11, 12, and 13. The other configurations are substantially the same.

In the second embodiment, in each of the pair of rollers 11, 12, and 13, the protruding portions 113, 123, and 133 are provided on the rollers 111, 121, and 131 positioned on the first surface 31a side (opposing the first surface 31a).

The protruding portions 113 are provided at opposite ends the roller 111 in the first direction. The protruding portions 123 are provided at opposite ends of the roller 121 in the first direction. The protruding portions 133 are provided at opposite ends of the roller 131 in the first direction.

In the present embodiment, the case where the protruding portions 113, 123, and 133 are provided at opposite ends of the rollers 111, 121, and 131 is exemplified, but the present disclosure is not limited thereto. The protruding portions 113, 123, and 133 may be provided at least at ends of the rollers 111, 121, and 131 which are located between the strip electrode layers 32 adjacent to each other in the first direction when viewed from the normal direction of the first surface 31a.

The protruding portions 113, 123, and 133 may be formed by projecting the surface layers of the rollers 111, 121, and 131 in the radial direction, or may be formed by welding a resin to the surface layers of the rollers 111, 121, and 131. The protruding portions 113, 123, and 133 may be formed by mounting a ring member such as an O-ring on the surface layers of the rollers 111, 121, and 131 in an interchangeable manner.

The manufacturing method of the electrode for a secondary battery according to the second embodiment basically conforms to the manufacturing method of the electrode for a secondary battery according to the first embodiment.

Also in the second embodiment, when manufacturing the electrode for a secondary battery, steps S10 to S13 are performed in substantially the same manner as in the first embodiment. In step S11, the substrate 31 and the sheet electrode layer 33 are sandwiched between the rollers 112, 122, and 132 positioned on the second surface 31b side of the pair of rollers 11, 12, and 13 and the protruding portions 113, 123, and 133 in a region corresponding to a gap between the adjacent strip electrode layers 32.

This makes it possible to reliably press the electrode layer 33 even in the region corresponding to the gap between the strip electrode layers 32 adjacent to each other, thereby more uniformly pressing the electrode layer 33. As a result, variation in density and thickness of the electrode layer 33 can be further suppressed as compared with Embodiment 1.

In the above description, the case where a plurality of pairs of rollers have three pairs of rollers 11, 12, and 13 is exemplified, but the number of pairs of rollers is not limited to three, and may be two or four or more.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method of manufacturing an electrode for a secondary battery, the method comprising:
preparing an electrode sheet including
a plurality of strip electrode layers provided on a first surface of a substrate, the strip electrode layers being arranged at intervals in a first direction, and
a sheet electrode layer provided on a second surface of the substrate opposite to the first surface, the sheet electrode layer being continuous in the first direction; and
pressing the electrode sheet transported in a transport direction crossing the first direction, using a plurality of pairs of rollers arranged to be displaced from each other in the first direction, wherein
in the pressing, the plurality of strip electrode layers and the sheet electrode layer are held between rollers of the plurality of pairs of rollers, in a state where opposite ends, in the first direction, of each of the rollers are located at respective positions that do not overlap the plurality of strip electrode layers, as seen in a normal direction to the first surface.

2. The method of manufacturing an electrode for a secondary battery according to claim 1, wherein as a roller of the pair of rollers that is located on the first surface, a roller is used that has a protruding portion to enter a gap between the strip electrode layers adjacent to each other in the first direction as seen in the normal direction to the first surface, the protruding portion being provided at an end of the roller, the end being located between the strip electrode layers adjacent to each other in the first direction.

3. The method of manufacturing an electrode for a secondary battery according to claim 2, wherein in the pressing, in a region corresponding to the gap, the substrate and the sheet electrode layer are held between a roller of the pair of rollers that is located on the second surface and the protruding portion.

4. The method of manufacturing an electrode for a secondary battery according to claim 1, comprising:
measuring, at a site downstream of each of the plurality of pairs of rollers in the transport direction, a thickness of the strip electrode layers pressed by the plurality of pairs of rollers; and
feeding back, to the pressing, information about the measured thickness, wherein
in the pressing, a press pressure for each of the plurality of pairs of rollers is adjusted based on the fed back information.

5. The method of manufacturing an electrode for a secondary battery according to claim 1, wherein at least one pair of rollers among the plurality of pairs of rollers differs from another pair of rollers, in a width in the first direction.
